(19) United States
(12) Patent Application Publication
(10) Pub. No.: US 2025/0182724 A1
(43) Pub. Date: Jun. 5, 2025

(54) SYSTEM AND METHOD FOR UNALIGNED SUPERVISION FOR AUTOMATIC MUSIC TRANSCRIPTION

(71) Applicant: RAMOT AT TEL-AVIV UNIVERSITY LTD., Tel Aviv (IL)

(72) Inventors: Amit Haim BERMANO, Tel Aviv (IL); Ben Adar Maman, Tel Aviv (IL)

(21) Appl. No.: 18/840,014

(22) PCT Filed: Jan. 27, 2023
(86) PCT No.: PCT/IB2023/050739

§ 371 Date: Aug. 20, 2024

Related U.S. Application Data
(60) Provisional application No. 63/312,219, filed on Feb. 21, 2022.

(51) Int. Cl. G10H 1/00; G06N 3/0442; G06N 3/0895; G06N 3/096

(52) U.S. Cl. CPC G10H 1/0008; G06N 3/0442; G06N 3/0895; G06N 3/096; G10H 2210/086

(57) ABSTRACT

Disclosed herein is a system that includes a memory storing computer-readable instructions and at least one processor to execute the instructions to perform pre-training of a machine learning model using synthetic data including random music instrument digital interface (MIDI) files, receive a first library of audio files, receive a second library of MIDI files, each MIDI file having a corresponding audio file in the first library, align each midi file in the second library with the corresponding audio file in the first library, feed the first library and the second library into the machine learning model to train the machine learning model to perform musical transcribing of at least one musical instrument in an audio file, and receive an audio file and perform automatic transcription of at least one musical instrument in an audio file using the machine learning model based on expectation maximization.

### CROSS-REFERENCE TO RELATED APPLICATION

This application is a National Phase entry of International Application No. PCT/IB2023/050739 under § 371 and is related to and claims priority to U.S. Patent Application No. 63/312,219, filed Feb. 21, 2022, entitled “Weakly-Supervised Multi-Instrument Transcription,” each of which is incorporated herein by reference in its entirety.

### FIELD OF THE DISCLOSURE

The present disclosure is directed to a system and method for unaligned supervision for automatic music transcription.

### BACKGROUND

The two common forms of musical transcription are note-level, where start (onset)/end (offset) note events are detected, and frame-level transcription, where pitches are predicted at every given time, implicitly determining the duration of notes. Other forms of transcription include stream-level, where the performance is segmented into different streams or voices. Segmentation can be according to instrument, but can also be between instances of the same instrument.

While early works reduced the task of transcription to detection of active notes per-frame, later works show the advantage of breaking down the detection into two components: onsets—beginning of notes, and frames—presence of notes. This is based on the observation that the more important and distinguished part of a note event is its onset.

In multi-instrument transcription, the simpler form ignores instrument classes, assigning a single class for each pitch. Only a handful of conventional approaches address the problem of note-with-instrument transcription. However, previous approaches do not provide the ability to label notes appropriately.

It is with these issues in mind, among others, that various aspects of the disclosure were conceived.

### SUMMARY

The present disclosure is directed to a system and method for unaligned supervision for automatic music transcription. The system may include at least one computing device having a transcription application. The transcription application may receive a synthetic or otherwise supervised dataset and train a musical transcriber machine learning model on the synthetic data. Additional training may occur in an M-step of expectation maximization (EM) by aligning a first library of audio files with a second library of MIDI files of the audio files. This may produce an aligned dataset of the first library and the second library. The aligned dataset may be used to further train the transcriber using pitch shift augmentation. The transcriber may be used when trained to provide musical transcription predictions of at least one musical instrument in a received audio file.

In one example, a system may include a memory storing computer-readable instructions and at least one processor to execute the instructions to perform pre-training of a machine learning model using synthetic data comprising random music instrument digital interface (MIDI) files, receive a first library of audio files, receive a second library of MIDI files, each MIDI file having a corresponding audio file in the first library, align each midi file in the second library with the corresponding audio file in the first library, feed the first library and the second library into the machine learning model to train the machine learning model to perform musical transcribing of at least one musical instrument in an audio file, and receive an audio file and perform automatic transcription of at least one musical instrument in an audio file using the machine learning model based on expectation maximization.

In another example, a method may include performing, by at least one processor, pre-training of a machine learning model using synthetic data comprising random music instrument digital interface (MIDI) files, receiving, by the at least one processor, a first library of audio files, receiving, by the at least one processor, a second library of MIDI files, each MIDI file having a corresponding audio file in the first library, aligning, by the at least one processor, each midi file in the second library with the corresponding audio file in the first library, feeding, by the at least one processor, the first library and the second library into the machine learning model to train the machine learning model to perform musical transcribing of at least one musical instrument in an audio file, and receiving, by the at least one processor, an audio file and performing automatic transcription of at least one musical instrument in an audio file using the machine learning model based on expectation maximization.

In another example, a non-transitory computer-readable storage medium may have instructions stored thereon that, when executed by a computing device cause the computing device to perform operations, the operations including performing pre-training of a machine learning model using synthetic data comprising random music instrument digital interface (MIDI) files, receiving a first library of audio files, receiving a second library of MIDI files, each MIDI file having a corresponding audio file in the first library, aligning each midi file in the second library with the corresponding audio file in the first library, feeding the first library and the second library into the machine learning model to train the machine learning model to perform musical transcribing of at least one musical instrument in an audio file, and receiving an audio file and performing automatic transcription of at least one musical instrument in an audio file using the machine learning model based on expectation maximization.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a diagram of unaligned supervision for automatic music transcription according to an example of the instant disclosure.

FIG. 2 shows an example method performed by a system for unaligned supervision for automatic music transcription and an example computing device according to an example of the instant disclosure.

FIG. 3 is a flowchart of a method of performing automatic transcription of at least one musical instrument in an audio file according to an example of the instant disclosure.

FIG. 4 shows tables with piano transcription results and string and wind instruments transcription results according to an example of the instant disclosure.

FIG. 5 shows tables with guitar transcription results and instrument-sensitive transcription results according to an example of the instant disclosure.

FIG. 6 shows a table indicating the effect of different labeling methods according to an example of the instant disclosure.

FIG. 7 shows a table with instrument distribution in self-collected data and a table with alignment results according to an example of the instant disclosure.

FIG. 8 shows a table with effect of pitch shift when evaluating on data and a table that shows the effect of repeated labeling according to an example of the instant disclosure.

FIG. 9 shows a table with velocity results and a table with transcription results according to an example of the instant disclosure.

FIG. 10 shows a table with note-with-offset scores for different tolerance thresholds and a table associated with training with unaligned supervision according to an example of the instant disclosure.

FIG. 11 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, embodiments of the invention may be described in the context of specific applications; however, the embodiments of the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that embodiments of the present invention can be carried out in a variety of ways, and does not require any of the specific features described herein. Also, well-known functions or constructions are not described in detail since they would obscure embodiments of the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of embodiments of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Multi-instrument Automatic Music Transcription (AMT), or the decoding of a musical recording into semantic musical content, is one of the holy grails of Music Information Retrieval. Current AMT approaches are restricted to piano and (some) guitar recordings, due to difficult data collection. In order to overcome data collection barriers, previous AMT approaches attempt to employ musical scores in the form of a digitized version of the same song or piece. The scores are typically aligned using audio features and strenuous human intervention to generate training labels. The system and method discussed herein provide Note_{EM}, a method for simultaneously training a transcriber and aligning the scores to their corresponding performances, in a fully-automated process. Using this unaligned supervision scheme, complemented by pseudo-labels and pitch shift augmentation, the method can enable training on in-the-wild recordings with unprecedented accuracy and instrumental variety. Using only synthetic data and unaligned supervision, the system can provide SOTA note-level accuracy of the MAPS dataset, and large favorable margins on cross-dataset evaluations. The system provides robustness and ease of use. Additionally, the system provides comparable results when training on a small, easily obtainable, self-collected dataset. It is possible to provide alternative labeling to the MusicNet dataset, which can be more accurate.

Automatic Music Transcription (AMT) includes the task of decoding musical notes from an audio signal, and is one of the most central tasks in Music Information Retrieval (MIR). AMT may include transcribing audio recordings into a symbolic representation. It benefits musicology and music education, musical search, and could even aid in realistic music synthesis. AMT is challenging due to several reasons, due to effects such as notes sharing partial frequencies, polyphony (simultaneous notes played together, analogous to occlusions in computer vision), echo effects, and multi-instrument performances, escalating complexity. However, AMT presents a number of difficulties because music signals often include multiple simultaneous sound sources over time and frequency.

Unsurprisingly, similarly to fields such as Computer Vision and Natural Language Processing, deep neural networks have contributed to AMT as well. However, as deep neural networks (DNNs) require massive amounts of training data, progress is limited. The main bottleneck is that manual annotation is severely infeasible, even if done by experts, as it requires highly precise timing. For this reason, for most instruments no datasets of highly accurate annotation have been collected. Collection efforts have concentrated mainly on two instruments. Guitar annotations are done semi-automatically with human verification, in a difficult to scale process. For the piano, unique equipment (such as the Disklavier) logs key activity during performance, making annotation trivial and data collection simpler. According to an example, the system utilizes a guitar dataset for evaluation that has only three hours of recordings, compared to one hundred forty hours of piano material. It is therefore not surprising that most AMT literature concentrates on the latter, where supervision and evaluation are clean and readily available.

As it turns out, even within the case of the piano, supervised detectors struggle to generalize to variances in the instrument or environment, let alone from synthetic to real data. For this reason, for example, the accuracy of state of the art (SOTA) methods degrades in cross-dataset evaluation (e.g., training on the piano recordings of the MIDI and Audio Edited for Synchronous Tracks and Organization (MAESTRO) dataset, and testing on those of MIDI Aligned Piano Sounds (MAPS), or other cross dataset evaluations. To mitigate these data intensive requirements, a popular approach seeks to annotate existing recordings through alignment of real performances to their corresponding musical score. In other words, an easily obtainable digitized performance (or MIDI) of a musical piece is aligned to a real recorded performance. After the MIDI is warped to best match the recording, it is used as annotation. This is how, for example, the popular MusicNet dataset was constructed (with the support of human verification). While promising, the alignment quality this approach demonstrates is not high enough to be used as labeling for network training. Indeed, the aforementioned dataset is notorious for its labeling inaccuracies.

As noted herein, an alignment process could be intertwined with the training of the transcriber, through an Expectation Maximization (EM) framework. The system provides Note_{EM}, a framework that supports unaligned supervision, based on easy-to-obtain musical scores to supervise in-the-wild recordings. The process may include three steps. First, the system utilizes an off-the-shelf architecture proposed for transcription and bootstraps the training using synthetic data. Second, for an E-step, the system uses a resulting network to predict the transcription of unlabeled recordings. The unaligned score is then warped based on the predictions as likelihood terms, and used as labeling. For the M-step, the transcriber itself is trained on the new generated labels. Depending on the metric, best results can be obtained when performing one or two such E-M iterations. In any case, alignment based on network predicted likelihoods is considerably more accurate than alignment based on spectral features. The system also enables better handling of inconsistencies between the audio and the score, which are inevitable.

Using this scheme, the system provides transcription accuracy that outperforms all existing methods on cross-dataset evaluations by a large margin for both the note- and frame-level metrics. For example, the system can reach 89.7% note-level and 77.0% frame-level F1 score on the MAESTRO test set (without using MAESTRO training data). Conventional approaches reach 28% and 60% when excluding MAESTRO data from training. Furthermore, the system provides note-level accuracy that compares or even surpasses fully supervised piano/guitar-specific transcription methods. The system can be trained on synthetic data and unaligned supervision alone.

Note_{EM} also enables simple and convenient training on different instruments and genres. To demonstrate this, the system trains the network on other instruments, such as violin, clarinet, harpsichord, and many others—between eleven and twenty-two instruments, depending on the configuration. Furthermore, to evaluate the method's usability, the system is trained using a small-scale self-collected set of musical performances and corresponding unaligned supervision, and observes similar accuracy. The system also generates alternative labeling to the aforementioned MusicNet dataset, known herein as MusicNet_{EM}, and demonstrates it is more accurate. Finally, the system provides generalization capabilities, through the high quality transcription of unseen instruments and genres such as rock or pop (in which case transcription is pitch only).

As an example, the system provides:

Note_{EM}—A general framework for training polyphonic (multi-instrument) transcribers using unaligned supervision, allowing the use of in-the-wild recordings for training.

Using the framework, the system provides a new SOTA note-level F1-score on the MAPS dataset of 87.3% (vs. 86.4% of supervised in conventional approaches), and considerable improvement for cross-dataset evaluations. This is accomplished even though training is done using less supervision and less data (˜thirty-four vs. ˜one hundred and forty hours).

The system provides unprecedented generalization for the machine learning model to unknown or new instruments and musical genres.

Additionally, the system provides alternative annotation for MusicNet, denoted MusicNet_{EM}, which is shown to be more accurate.

The two common forms of transcription are note-level, where start (onset)/end (offset) note events are detected, and frame-level transcription, where pitches are predicted at every given time, implicitly determining the duration of notes. Other forms of transcription include stream-level, where the performance is segmented into different streams or voices. Segmentation can be according to instrument, but can also be between instances of the same instrument.

While early works reduced the task of transcription to detection of active notes per-frame, later works show the advantage of breaking down the detection into two components: onsets—beginning of notes, and frames—presence of notes. This is based on the observation that the more important and distinguished part of a note event is its onset.

In multi-instrument transcription, the simpler form ignores instrument classes, assigning a single class for each pitch. Only a handful of works also address the problem of note-with-instrument transcription. As noted herein, the system provides cleaner and more attainable labeling, thus clearly surpassing the performance of these works.

For piano transcription, the main benchmarks are MAPS and MAESTRO. The MAPS dataset consists of synthetic and real piano performances, where usually the real performances are used for testing. MAESTRO is a large-scale dataset containing one hundred and forty hours of classical western piano performances, with fine and accurate annotation, generated using a Disklavier. The accurate annotation allows outstanding transcription quality. However, the main drawback of this dataset is the lack of variety: It contains only piano recordings, which prevents generalization to other musical instruments, and even to varieties in recording environments and pianos. Thus, transcription quality degrades significantly even when testing the model on other piano test sets, such as MAPS.

For annotation of guitar transcription, a previous approach relies on hexaphonic pickup (separated to six strings), breaking the problem down into annotation of monophonic music which is simpler than polyphonic. Unfortunately, this approach still requires manual labor, which limits broad data collection. This results in a small dataset—four hours in total. Hence, this dataset can be used for evaluation but is less effective for training in-the-wild transcribers.

For other instruments, or multi-instrument transcription, the main existing dataset is MusicNet, which contains thirty-four hours of classical western music, performed on various instruments. The annotation was obtained by aligning separate-sourced (i.e., by other performers) MIDI performances, rendered into audio, with the real recordings, according to low frequencies. This dataset has the clear advantage of variety, both in instruments and in recording environments, as recordings were gathered from many different sources. However, despite being verified by musicians, the alignment is of poor quality, and timing of notes is not precise, significantly inhibiting learning and performance, as shown. Similar datasets exist including SU, extended SU, and URMP datasets, which suffer from similar limitations and are small.

Regarding instrument-sensitive transcription (note-with-instrument), few works have been done, because of the aforementioned limitations of multi-instrument datasets. A previous approach trains and tests on MusicNet for this task, but reported note-level accuracies have been very low, including below 51% on all instruments except for piano and violin, having accuracies ˜69% and ˜61% respectively. Another approach trained on a mixture of datasets—MAESTRO, GuitarSet, MusicNet and Slakh2100 (Synthetic). The approaches map the spectrogram into a sequence of semantic MIDI events, taking an NLP seq2seq approach. This setting is flexible and allows to easily represent multi-instrument transcription. However, the performance on the cross-dataset, or zero-shot task, is low (below 33% on note-level F1), and performance on MusicNet is low, even when training on MusicNet (50% note-level F1 at most).

It is important to note, that none of the latter works propose any framework or method for weakly- or self-supervised transcription. One approach trained instrument-insensitive transcription without supervision using a reconstruction loss and Virtual Adversarial Training, but the framework described herein performs much better, and also allows instrument-sensitive transcription. The system provides a framework for multi-instrument polyphonic music, including instrument-sensitive transcription.

A weak transcriber can still produce accurate predictions if the global content of the outcome is known up to a warping function. These accurate predictions, in turn, can be used as labels to further improve the transcriber itself. As noted herein, this approach is more accurate than that of pseudo-labels due to the unaligned known global content. The weak transcriber thus transforms weak supervision into full supervision and refines itself.

The system and method, described in pseudo-code below, relies on Expectation Maximization (EM), and involves three components: (I) Synthetic data initial training, (II) aligning real recordings with separate-source MIDI, including deciding which frames to use and which not to use, and (III) transcriber refinement, including pitch-shift equivariance augmentations.

### Expectation Maximization (EM)

Expectation Maximization (EM) is a paradigm for unsupervised or weakly-supervised learning, where labels are unknown, and are assigned according to maximum likelihood. It can be formulated as an optimization problem:

$${Θ}^{*} = {arg max}_{Θ} {max}_{{y}_{1} , … , {y}_{n}} {P}_{Θ} ( {a}_{1} , … , {a}_{n} , {y}_{1} , … , {y}_{n} )$$

where a₁, . . . , aₙ are data samples, and y₁, . . . , yₙ are their unknown labels. The optimization problem can be solved by alternating steps, repeated iteratively until convergence (assuming some pre-training or bootstrapping of Θ):

$${y}_{1} , … , {y}_{n} = {arg max}_{{y}_{1} , … , {y}_{n}} {P}_{Θ} ( {a}_{1} , … , {a}_{n} , {y}_{1} , … , {y}_{n} ) \qquad ( 1 )$$

$${Θ}^{*} = {arg max}_{Θ} {P}_{Θ} ( {a}_{1} , … , {a}_{n} , {y}_{1} , … , {y}_{n} ) \qquad ( 2 )$$

which are referred to as the E-step (1) and the M-step (2).

In this case, the data samples a₁, . . . , aₙ are the unlabeled audio recordings, and y₁, . . . , yₙ are the unknown per-frame labels. It can be assumed that the recordings are performances of pre-defined musical pieces m₁, . . . , mₙ, such as in classical music, in the form of MIDI from other performers. The system can perform the E-step by aligning m₁, . . . , mₙ with the predicted probabilities over a₁, . . . , aₙ using dynamic time warping (DTW). The system initializes Θ by training on synthetic data which is (trivially) supervised.

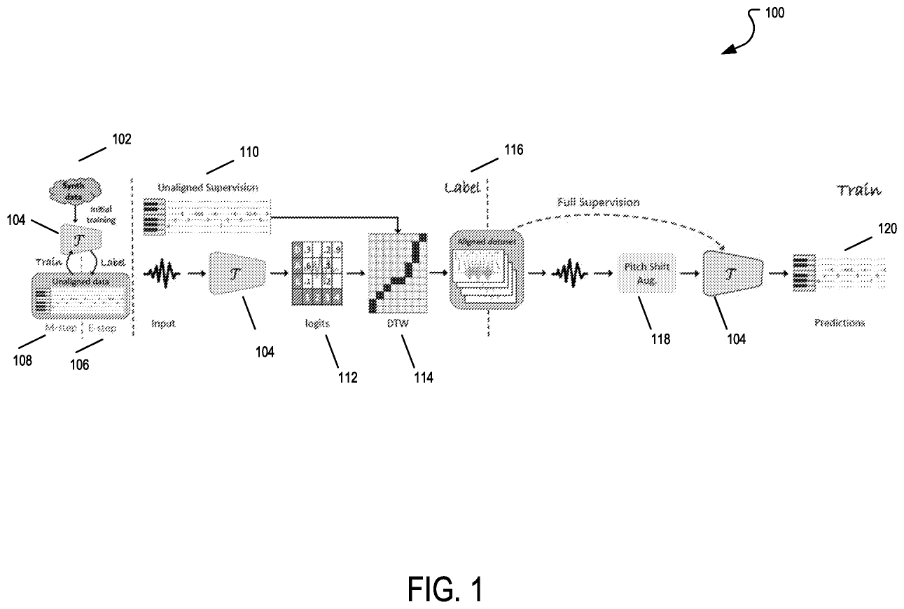

As shown in FIG. 1, an example method of unaligned supervision for automatic music transcription 100 is shown. Given a synthetic or otherwise supervised dataset 102, and an unaligned domain, the system starts by training a transcriber T 104 on the synthetic data 102. Next, the system uses the transcriber 104 to label the domain (E-step) 106. The system uses this as supervision for further training, resulting in a stronger T transcriber model (M-step) 108.

The unaligned supervision scheme includes an alignment step 110. Probabilities for each note at each timestep are computed using the transcriber T 104. Then, the unaligned labels are warped using DTW 114 to maximize the logits 112.

The warped results are accumulated into the aligned dataset 116, which can be used to retrain the transcriber T 104. During training the system uses pitch shift augmentation 118, to improve robustness and performance and the transcriber can be used to provide transcription results 120.

### Initial Training

The system can use synthetic data 102 to train an architecture. Different architectures are possible, but the example architecture discussed herein has proven to be effective for supervised piano transcription, reaching 95% note-level and 90% frame-level F1 scores. It has separate detection heads for onsets, offsets, and frames, allowing to perform alignment according to semantic information. As determined, onset information is the most effective for alignment. This initial network can be trained to detect only pitch, without instrument, but it can also be further trained to detect an instrument as well.

### Labeling

The system can label real data using dynamic time warping 114 between the initial network's predicted probabilities and the corresponding MIDIs. This is contrary to conventional approaches that have computed the dynamic time warping in the frequency space.

It has been determined that MIDI guided alignment yields more accurate labels than simple thresholding. It also provides instrument information.

The alignment process is depicted in FIG. 1, and can rely on Dynamic Time Warping (DTW) 114. Using DTW, the system searches for a chronologically monotonic mapping between the unaligned labeling and its corresponding recording, such that for each selected note the probability, as predicted by the transcription model, is maximized.

Using the network's predicted probabilities as local descriptors for DTW has the following advantages:
(i) Inconsistencies—For a separate-source MIDI (i.e., originating from a different performer), inconsistencies between the performances is inevitable. This includes repetitions of cadenzas, and more subtle nuances, such as trills, or in-chord order changing. Precise onset timing can be adjusted locally for each note independently according to predicted likelihoods. Failed detection, whether false positive or false negative, can be avoided based on network's probabilities, i.e., pseudo-labels can also be leveraged in addition to the alignment.
(ii) Label refinement—the labeling process can be repeated during training, thus refining the labels, since the network has improved.
(iii) DTW computation speed—for DTW descriptors, it is possible to project the eighty-eight pitches into a single octave (twelve pitches) using maximum activation across octave, hence representation length for DTW is twelve rather than fifty as determined in previous approaches. After projection, for an audio recording of ˜2:30 minutes, DTW takes ˜1 second.

### Pseudo Labels

As aforementioned, the alignment can produce false detections, whether positive or negative. To avoid this false detection automatically, and still leverage all data, the system labels classes with predicted confidence above a threshold Tₚₒₛ as positive, and classes with predicted confidence beneath a threshold T_{neg} as negative, regardless of the alignment. Classes with probability 0.5<p<Tₚₒₛ which were not marked positive are considered unknown and the system does not back-propagate loss through them. The system can do this to allow detection of onsets undetected by the labeling. The system does not do the same for negative detection (i.e., T_{neg}<p<0.5) as there is already a strong bias against onset detection, as onsets are very sparse (an onset lasts a single frame).

It has been determined to use thresholds Tₚₒₛ=0.75 and T_{neg}=0.01 for all classes—onsets, frames, and offsets. The system can use a low negative threshold since the MIDI performance already constrains the labels, and activations (whether onset, frame, or offset) are sparse, thus mode collapse is less of an issue.

### Tonality—Pitch Shift Equivariance

Music transcription has a unique inherent structure, where a pitch shift on the waveform induces a corresponding predetermined translation of the labels. The system can leverage this structure by enforcing consistency across pitch shift. The system can create eleven additional pitch shifted copies of data, with pitch shifts (in semitones): si=i+αi, −5≤i≤5, αi˜U(−0.1, 0.1), where U(−0.1, 0.1) is the uniform distribution on the interval [−1, 1]. The system computes the labels only for the original copy, and for each copy shift labels accordingly. This not only augments the data by an order of magnitude, but also implicitly enforces consistency across pitch shift, serving as a regularization, forcing the model to learn tonality.

### Instrument—Sensitive Transcription

### (Note-with-Instrument)

In this setting, it is possible to define a distinct class for each combination of pitch and instrument, i.e., the number of classes C is (number of pitches)−(number of instruments).

The system starts with instrument-insensitive training on synthetic data. To adjust the transcriber to the new task of also detecting instruments, it is possible to duplicate the weights of the final linear layer of the onset stack I times: once for each instrument, and one copy to maintain instrument-insensitive prediction. This redundancy serves as regularization and improves learning. Thus, at the beginning of instrument-sensitive training, upon detection of a note, the transcriber will detect the note as active on all instruments. During training the transcriber will learn to separate instruments, according to the labels. The system applies the same labelling process to this scenario as well—the difference only being more classes. The system maintains the low representation length of 12 for DTW computation by maximizing activation both across octave and instrument. To allow the transcriber 104 (which is initially insensitive to instrument) to learn instrument separation, the system does not use pseudo-labels in the initial labelling, only from the second labeling iteration.

### Experiments

For all experiments, the system can use an architecture that allows the ability to handle instrument variety. As an example, as opposed to previous approaches, the system increases network width compared to conventional solutions. The system uses LSTM layers of size 384, convolutional filters of size 64/64/128, and linear layers of size 1024.

As an example, all recordings can be resampled to a 16 kHz sample rate, and use the log-mel spectrogram as the input representation, with two hundred and twenty-nine log-spaced bins (i.e., input dimensionality of two hundred and twenty-nine). The system can use the mean BCE loss, with an Adam optimizer, with gradient clipped to norm three, and batch size eight. The initial synthetic model can be trained for 350K steps. In one example, this approach may take about sixty-five hours on a pair of NVIDIA GeForce RTX 2080 Ti GPUs. Further training on real data can be done for 90*|Dataset| steps. In the case of MusicNet_{EM}, this is ˜90*310=28K iterations. For most experiments, labeling is performed twice: once after synthetic training, and once after 45*|Dataset| steps. For perspective, MusicNet_{EM} training, which includes 28K iterations and 2 DTW labelling iterations, may take sixteen hours on a pair of NVIDIA GeForce RTX 2080 Ti GPUs.

The effect of the pitch-shift augmentation can be seen in Table One and Table Three, further discussed below. Comparison of labeling methods (alignment, pseudo labels, and a combination of both) can be seen in Table Five. Further ablation studies, considering various steps, such as EM iterations, alignment quality, and others, can be found in the Appendix.

### Data & Instrument Distribution

In experiments, it was possible to use three datasets:

MIDI Pop Dataset (AI, 2020) is a large collection of MIDI files. The data consists of almost 80,000 songs, from which some may be randomly selected ˜8,500. The random selections can be synthesized into audio. ˜4,500 of the performances of length 278:09:01 hours, are mp3 compressed, and the rest with lossless flac compression. In total 501:11:30 hours of audio were synthesized from MIDI. The data is used during a pre-training step. Note that for flexibility, as an example, it is possible to only use pitch labels from this data, without instrument specific labels.

MusicNet comprises recordings of multiple instruments in an unbalanced mix. The labels for this dataset are of notorious quality, as they were generated by alignment to musical scores in preprocess. Most recordings are of a piano (˜fifteen out of ˜thirty-four hours are piano solo, and ˜seven other hours include the piano). It is possible to use the recordings of this dataset, and their provided unaligned corresponding musical scores. Instead of the provided labels (or aligned scores), the system provides MusicNet_{EM}—an alternative labeling generated by the framework—that is superior in quality.

As another example, the system can use a Self-Collected dataset such as manually gathered seventy-four additional hours of recordings, including over thirty hours of orchestra, five hours of solo guitar (pieces by Albeniz, Sor, and Tarrega), eleven hours of harpsichord (six hours solo), and more. It is possible to use this data to supplement or replace MusicNet in experiments. The dataset can be created to demonstrate the simplicity of unaligned data collection, and show similar quantitative results compared to the carefully curated official datasets.

### Evaluation

As described herein, the training process for all experiments can be similar—the network is trained on the synthetic data rendered from the MIDI pop dataset with full supervision, and is then fine-tuned using the MusicNet and/or Self-Collected audio files, with only unaligned labeling. Since quality ground truth data is difficult to obtain, it is possible to use the test sets of other datasets for quantitative evaluation. Due to dedicated hardware, the datasets provide accurate transcription, but to limited instruments. As an example, the system does not use these sets (MAESTRO, MAPS, or GuitarSet) for training.

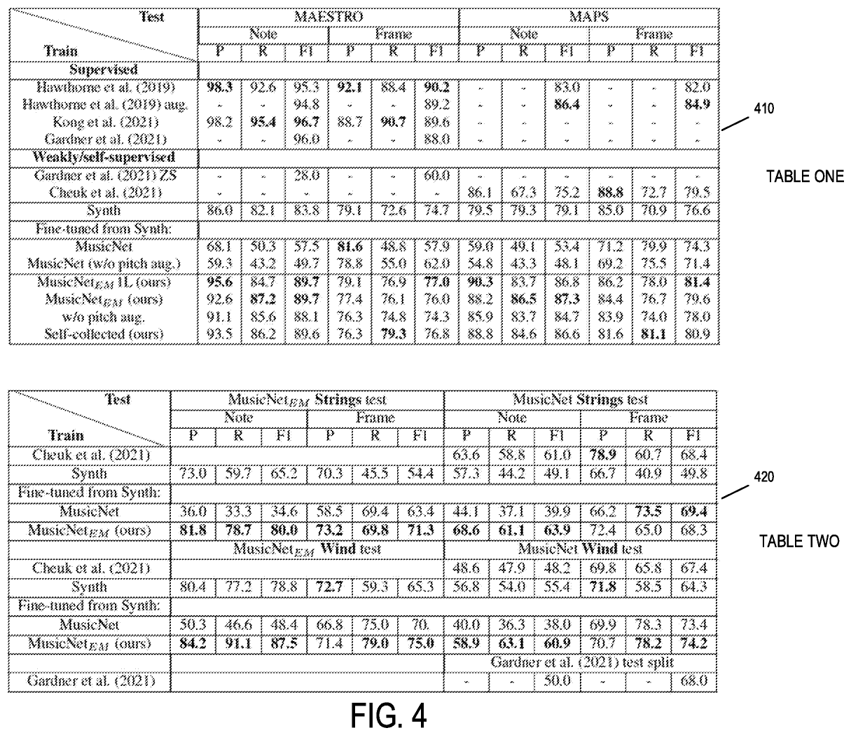

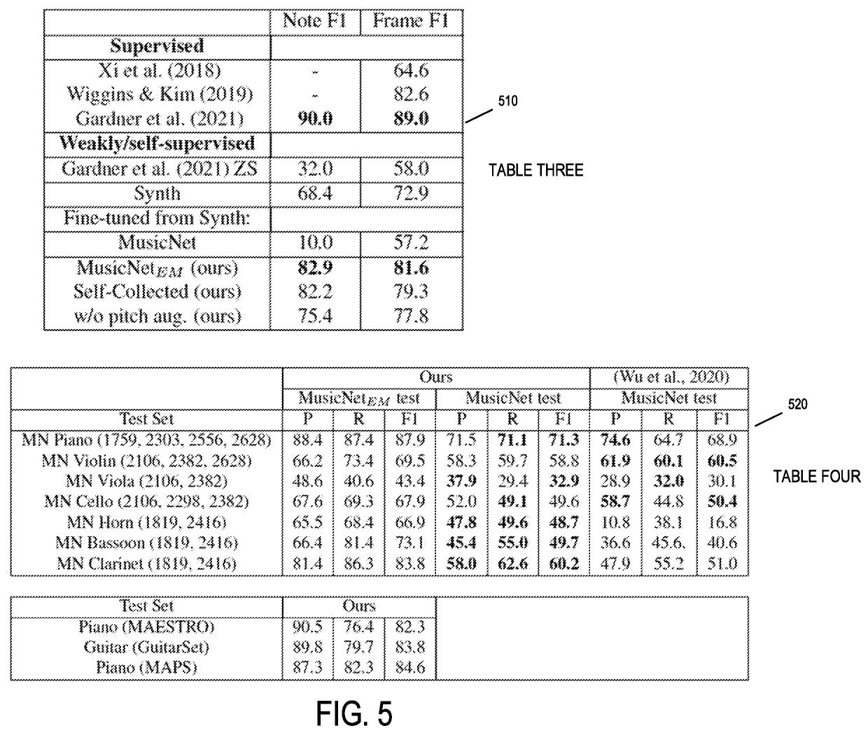

The system and method can be performed on piano, guitar, strings, and wind instruments, in an instrument-sensitive (i.e., note-with-instrument, see FIG. 5, Table Four 520), or an instrument-insensitive (see FIG. 4, Table One 410, FIG. 4, Table Two 420 (MusicNet test), and FIG. 5, Table Three 510 (GuitarSet)) manner.

For instrument-insensitive transcription Table One 410, Table Two 420, and Table Three 510 show the metrics note (onset detection within 50 ms or less) and frame (detection of active pitches, determining note duration). Note-with-offset with varying thresholds can be found in the Appendix. For instrument-sensitive transcription (Table Four 520) shows the note-with-instrument metric, which uses the same 50 ms timing rule, but only for notes of the correctly predicted instrument.

### Piano

Piano can be used to evaluate our system because it can provide test sets with reliable labeling (due to the use of the Disklavier), even though the network is trained for multi-instrument transcription. It is possible to evaluate on the MAPS and MAESTRO test sets. Results can be seen in Table One 410 (instrument-insensitive) and Table Four 520 (instrument-sensitive). As shown in Table One 410: The Synth model is the initial model trained on the MIDI Pop Dataset which serves as a baseline. In the following two experiments (MusicNet with or without pitch-shift) it is possible to fine-tune this model on MusicNet with the original annotation, which only worsens performance. In the following four experiments (bottom four rows) it is possible to fine-tune the initial Synth model on MusicNet with unaligned annotation (MusicNet_{EM}, using one or two labeling iterations) or on the Self-Collected data (using the default of two iterations).

In the four bottom rows of Table One 410 it can be seen that note-level accuracy is near-supervised level, even surpassing supervised-level on MAPS. This is despite training on different datasets and no direct supervision, let alone precise labeling of the exact same instrument. For frame-level accuracy, the task is more challenging, since note endings are typically weak and thus harder to decipher. While this expectedly induces lower F1 score for the MAESTRO dataset, it is possible to see near-supervised performance on MAPS. Note that the same training procedure done using original Music-Net annotations yields much lower accuracy. This strongly indicates that the annotation is more accurate. Similar results are achieved with self-collected data of ˜thirty hours of piano and guitar.

### Guitar

For guitar transcription, it is possible to evaluate on the GuitarSet dataset (which is not used for training). Results can be seen in Table Three 510 (instrument-insensitive) and table Four 520 (instrument-sensitive). Table Three 510 demonstrates generalization to a new instrument, since MusicNet_{EM} does not contain guitar performances. For unseen instruments, it is possible to only use the results predicted by the pitch-only part the network's output, using the same models as in Table One 410. For guitar training data in Table Four 520 it is possible to use the self-collected ˜five hours of guitar recordings together with MusicNet_{EM}. Results are consistent with the piano experiments, indicating significant improvements.

### String & Wind Instruments

As mentioned, existing annotation of the MusicNet dataset is notoriously inaccurate, and Table One 410 and Table Three 510 indicate that the annotation method discussed herein is more accurate. To further demonstrate this for other instruments, it is possible evaluate on the MusicNet test set using both the original annotation and as shown in Table Two 420. Test annotation is done as described herein, but without the pseudo labels step. Results can be seen in Table Two 420 (instrument-insensitive) and Table Four 520 (instrument-sensitive).

As can be seen in Table Two 420, on the note-level, there are conclusive results that the generated annotation used for training performs significantly better than training on the original annotation (over 20% difference) on both test annotations. This indicates the method can flexibly extend to novel material with cheap labeling.

### Instrument-Sensitive Transcription

### Training & Evaluation

For quantitative evaluation, it is possible to use the eleven instrument classes of MusicNet, with the addition of the guitar (see below), summing up to twelve instrument classes. Thus they can be evaluated on the MusicNet test set, on GuitarSet, on MAESTRO, and on MAPS. In the instrument-sensitive setting, a note is considered correct only if its predicted instrument is correct (note-with-instrument). It is possible to train on MusicNet_{EM} together with the self-collected guitar data, to allow guitar detection. Similar to Table Two 420, MusicNet test results can be shown both according to the annotation, and the original one. Results can be seen in Table Four 520. Metrics are unsurprisingly lower than Table Two 420, since instrument detection is required, and confusions can occur e.g., between violin and viola.

The metrics on the original MusicNet test annotation do not reflect performance well and thus MusicNet_{EM} is to be used.

Alignment Vs. Pseudo Labels

To evaluate the contribution of each of the components alignment with MIDI and pseudo labels, it is possible to train two additional models—one where the real audio recordings can be labeled only using pseudo labels obtained by thresholding with a 0.5 threshold, and one where labeling only uses alignment. Results can be seen in Table Five 610. As can be seen, alignment is a powerful step, especially on the note-level, performing better than psuedo-labels on all evaluation sets (MAPS, MAESTRO, and GuitarSet). Finally, while both the alignment and psuedo-labeling are shown to contribute to accuracy, combining both performs best on all three test sets, on both the note-level and frame-level.

The system and method discussed herein provide for multi-instrument transcription, from easily attainable unaligned supervision. The system provides strength for in-the-wild transcription, including cross-dataset evaluation. Additionally, it is possible to show the simplicity of collecting data for the framework, which generates annotation on its own in a fully-automated process. The system provides unprecedented transcription quality on a wide variety of instruments and genres.

The system could be used to extend to human voices, and additional effects could be added to the detection, such as velocity. In addition, adding a musical prior, driving predictions to only make sense musically (in a similar manner to an NLP) would also boost performance. The system could utilize generative models. DNN based models that synthesize realistic music, although producing realistic timbre, cannot produce coherent music without conditioning on notes. Generating realistic-sounding music conditioned on notes is ideal for musicians as it enables full control over the content of the produced music. The transcriptions produced can be used as a conditioning signal for training generative models, by learning the reverse mapping from transcriptions to original audio. Finally, additional E-M iterations on small data or specific performances, even during inference could be accomplished.

Aspects of a system and method for unaligned supervision for automatic music transcription includes at least one computing device. As an example, the system may have a memory storing computer-readable instructions and at least one processor to execute the instructions to perform pre-training of a machine learning model using synthetic data comprising random music instrument digital interface (MIDI) files, receive a first library of audio files, receive a second library of MIDI files, each MIDI file having a corresponding audio file in the first library, align each midi file in the second library with the corresponding audio file in the first library, feed the first library and the second library into the machine learning model to train the machine learning model to perform musical transcribing of at least one musical instrument in an audio file, and receive an audio file and perform automatic transcription of at least one musical instrument in an audio file using the machine learning model based on expectation maximization. As another example, the computing device may include one or more graphical processing units (GPUs) to perform the instructions in conjunction with or simultaneous with the at least one processor.

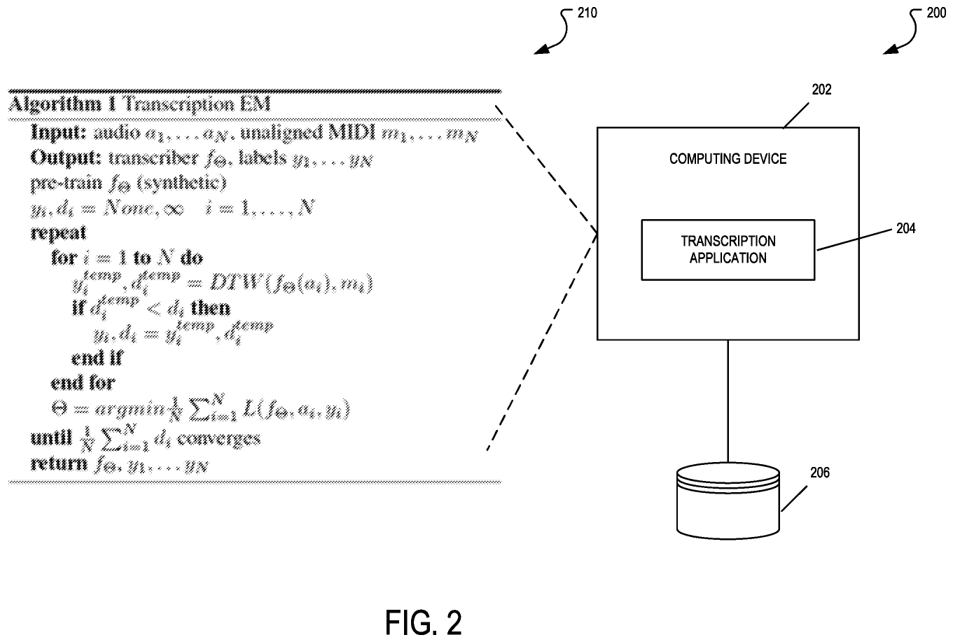

FIG. 2 is a block diagram of a system for unaligned supervision for automatic music transcription 200 according to an example of the instant disclosure. As shown in FIG. 2, the system 200 may include at least one computing device 202. The at least one computing device 202 may be in communication with at least one database 206.

The computing device 202 may have a transcription application 204 that may be a component of an application and/or service executable by the at least one computing device 202. For example, the transcription application 204 may be a single unit of deployable executable code or a plurality of units of deployable executable code. According to one aspect, the transcription application 202 may include one component that may be a web application, a native application, and/or a mobile application (e.g., an app) downloaded from a digital distribution application platform that allows users to browse and download applications developed with mobile software development kits (SDKs) including the APPLE® iOS App Store and GOOGLE PLAY®, among others.

The system 200 also may include a relational database management system (RDBMS), e.g., MySQL, or another type of database management system such as a NoSQL database system that stores and communicates data from the at least one database 206. The data stored in the at least one database 206 may be associated with the system such as synthetic data for pre-training, a first library of audio files and a second library of MIDI files, and data associated with the machine learning model providing transcription such as data associated with a machine learning model architecture, among other data.

The at least one computing device 202 may be configured to receive data from and/or transmit data through a communication network. Although the computing device 202 is shown as a single computing device, it is contemplated that the computing device 202 may include multiple computing devices.

The communication network can be the Internet, an intranet, or another wired or wireless communication network. For example, the communication network may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a near field communication (NFC) network, a satellite communications network, or an IEEE 802.11 standards network, as well as various communications thereof. Other conventional and/or later developed wired and wireless networks may also be used.

The computing device 202 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the computing device 202 further includes at least one communications interface to transmit and receive communications, messages, and/or signals. Additionally, the computing device 202 may have one or more graphical processing units (GPUs).

The computing device 202 could be a programmable logic controller, a programmable controller, a laptop computer, a smartphone, a personal digital assistant, a tablet computer, a standard personal computer, or another processing device. The computing device 202 may include a display, such as a computer monitor, for displaying data and/or graphical user interfaces. The computing device 202 may also include a Global Positioning System (GPS) hardware device for determining a particular location, an input device, such as one or more cameras or imaging devices, a keyboard or a pointing device (e.g., a mouse, trackball, pen, or touch screen) to enter data into or interact with graphical and/or other types of user interfaces. In an exemplary embodiment, the display and the input device may be incorporated together as a touch screen of the smartphone or tablet computer.

As an example, the computing device 202 may communicate data in packets, messages, or other communications using a common protocol, e.g., Hypertext Transfer Protocol (HTTP) and/or Hypertext Transfer Protocol Secure (HTTPS). One or more computing devices may communicate based on representational state transfer (REST) and/or Simple Object Access Protocol (SOAP). As an example, a first computer (e.g., the computing device 202) may send a request message that is a REST and/or a SOAP request formatted using Javascript Object Notation (JSON) and/or Extensible Markup Language (XML). In response to the request message, a second computer may transmit a REST and/or SOAP response formatted using JSON and/or XML.

FIG. 2 illustrates an example algorithm 210 executed by the computing device 202 according to an example of the instant disclosure. In one example, the transcription application 204 may perform the algorithm 210. As shown in FIG. 2, the input may include a first library of audio files and a second library of unaligned MIDI files that may be stored or obtained from one or more databases 206. The output may be a machine learning model that comprises a transcriber and labels. In a first step, the computing device 202 may perform pre-training of the machine learning model. Then, the computing device 202 may perform the expectation maximization to train the machine learning model.

Expectation Maximization (EM) is a paradigm for unsupervised or weakly-supervised learning, where labels are unknown, and are assigned according to maximum likelihood. It can be formulated as an optimization problem:

$${Θ}^{*} = {arg max}_{Θ} {max}_{{y}_{1} , … , {y}_{n}} {P}_{Θ} ( {a}_{1} , … , {a}_{n} , {y}_{1} , … , {y}_{n} )$$

where a₁, . . . , aₙ are data samples, and y₁, . . . , yₙ are their unknown labels. The optimization problem can be solved by alternating steps, repeated iteratively until convergence (assuming some pre-training or bootstrapping of Θ):

$${y}_{1} , … , {y}_{n} = {arg max}_{{y}_{1} , … , {y}_{n}} {P}_{Θ} ( {a}_{1} , … , {a}_{n} , {y}_{1} , … , {y}_{n} ) \qquad ( 1 )$$

$${Θ}^{*} = {arg max}_{Θ} {P}_{Θ} ( {a}_{1} , … , {a}_{n} , {y}_{1} , … , {y}_{n} ) \qquad ( 2 )$$

which are referred to as the E-step (1) and the M-step (2). The algorithm can include labeling data using dynamic time warping between the initial predicted probabilities and corresponding MIDIs.

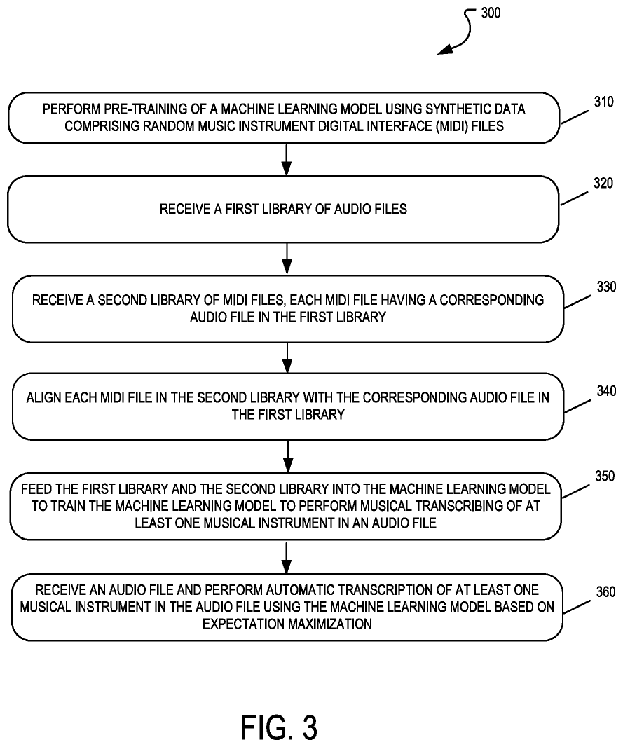

FIG. 3 illustrates an example method 300 of performing automatic transcription of at least one musical instrument in an audio file according to an example of the instant disclosure. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, the method 300 may include the computing device 202 performing pre-training of a machine learning model using synthetic data comprising random music instrument digital interface (MIDI) files at block 310.

Next, according to some examples, the method 300 may include receiving a first library of audio files at block 320. In one example, the first library may include the MusicNet database. As an example, each audio file in the first library may be one of a Free Lossless Audio Codec (flac) file and a MPEG-1 Audio Layer 3 (mp3) file.

Next, according to some examples, the method 300 may include receiving a second library of MIDI files, each MIDI file having a corresponding audio file in the first library at block 330.

Next, according to some examples, the method 300 may include aligning each MIDI file in the second library with the corresponding audio file in the first library at block 340. As an example, the aligning is accomplished using the machine learning model that was pre-trained.

Next, according to some examples, the method 300 may include feeding the first library and the second library into the machine learning model to train the machine learning model to perform musical transcribing of at least one musical instrument in an audio file at block 350.

Both block 340 and block 350 of method 300 may be repeated multiple times alternately, e.g., this is expectation maximization.

Next, according to some examples, the method 300 may include receiving an audio file and performing automatic transcription of at least one musical instrument in the audio file using the machine learning model and based on the expectation maximization at block 360. In some examples, the at least one musical instrument includes a piano, a guitar, a string instrument, and a wind instrument, among others.

According to some examples, the method 300 may include training the machine learning model using a transcriber trained for instrument insensitive transcription using the synthetic data as a pre-training step.

According to some examples, the method 300 may include performing the automatic transcription at a note-level accuracy.

According to some examples, the method 300 may include performing the automatic transcription to predict an instrument for each note in the audio file having multiple simultaneous musical instruments.

According to some examples, the method 300 may include generating annotation for each audio file in the first library using the corresponding MIDI file.

According to some examples, the method 300 may include aligning each audio file in the first library with the corresponding MIDI file in the second library using onset information.

According to some examples, the method 300 may include aligning each audio file in the first library with the corresponding MIDI file in the second library using dynamic time warping.

According to some examples, the method 300 may include training the machine learning model using one of unsupervised learning or weakly supervised learning.

According to some examples, the expectation maximization (EM) may include an E-Step having an equation comprising:

$${y}_{1} , … , {y}_{n} = {arg max}_{{y}_{1} , … , {y}_{n}} {P}_{Θ} ( {a}_{1} , … , {a}_{n} , {y}_{1} , … , {y}_{n} ) ,$$

each a being a data sample and each y being an unknown per-frame label.

According to some examples, the expectation maximization (EM) may include an M-Step having an equation comprising:

$$Θ = {arg max}_{Θ} {P}_{Θ} ( {a}_{1} , … , {a}_{n} , {y}_{1} , … , {y}_{n} ) ,$$

each a being a data sample and each y being an unknown per-frame label.

According to some examples, the expectation maximization (EM) utilizes an equation comprising:

$${Θ}^{*} = {arg max}_{Θ} {max}_{{y}_{1} , … , {y}_{n}} {P}_{Θ} ( {a}_{1} , … , {a}_{n} , {y}_{1} , … , {y}_{n} ) .$$

According to some examples, the method 300 may include performing instrument-sensitive training by detecting a note active on all instruments and labeling each note using the expectation maximization (EM). The labeling may include assigning labels to non-singular points and masking a loss to singular points. Additionally, the labeling may include labeling when a predicted confidence is above a particular threshold.

According to some examples, the machine learning model is generated using a machine learning architecture comprising long short-term memory (LSTM) layers having a size 384, convolutional filters having a size 64/64/128 and linear layers having a size 1024.

According to some examples, the method 300 may include using transfer learning to generate the machine learning model.

According to some examples, the method 300 may include performing instrument sensitive training by detecting a note active on all instruments.

As noted above, FIG. 4 shows tables including Table One 410 with piano transcription results and Table Two 420 having string and wind instruments transcription results according to an example of the instant disclosure. As noted in FIG. 4, as provided in Table One 410, the system and method 200 surpasses fully supervised note-level accuracy on the MAPS test set and is comparable to MAESTRO despite not being trained on it. As noted in FIG. 4 and as provided in Table Two 420, the system and method 200 provide string and wind instruments results that are impressive as compared with previous approaches.

FIG. 5 shows tables including Table Three 510 with guitar transcription results and Table Four 520 having instrument-sensitive transcription results according to an example of the instant disclosure. As noted in FIG. 5 and as shown in Table Three 510, the transcription results on GuitarSet provide results that improve upon previous conventional approaches. As noted in FIG. 5 and as shown in Table Four 520, the instrument-sensitive transcription results indicate marked improvements for horn, bassoon, and clarinet, among others.

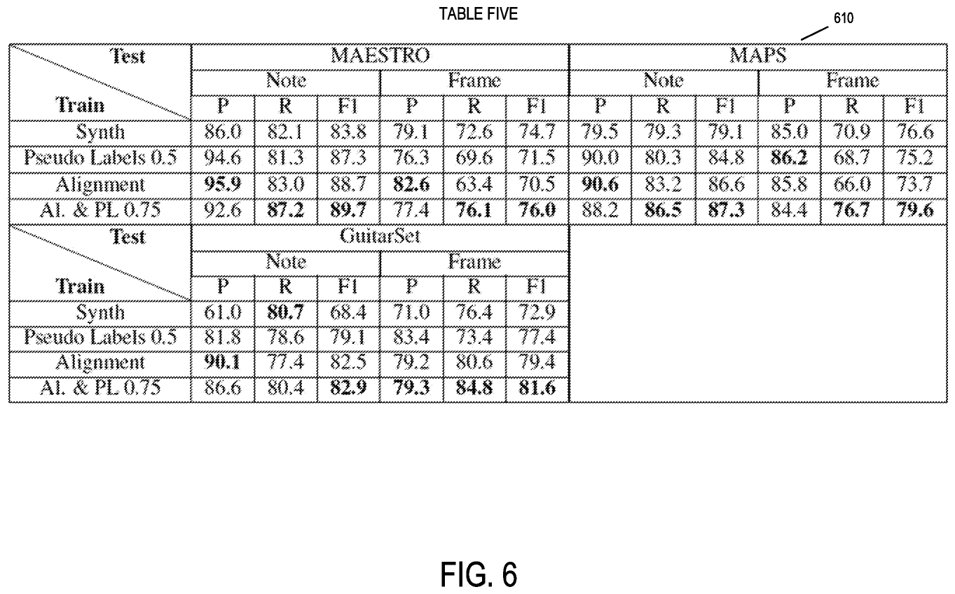

FIG. 6 shows a table including Table Five 610 indicating the effect of different labeling methods according to an example of the instant disclosure. As noted in FIG. 6 and shown in Table Five 610, there are effects associated with different labeling methods. In a pseudo label method, it is possible to use predictions of the network as labels without alignment with MIDI. In an alignment method, it is possible to align as discussed herein without using pseudo labels. It is also possible to use alignment and pseudo labels.

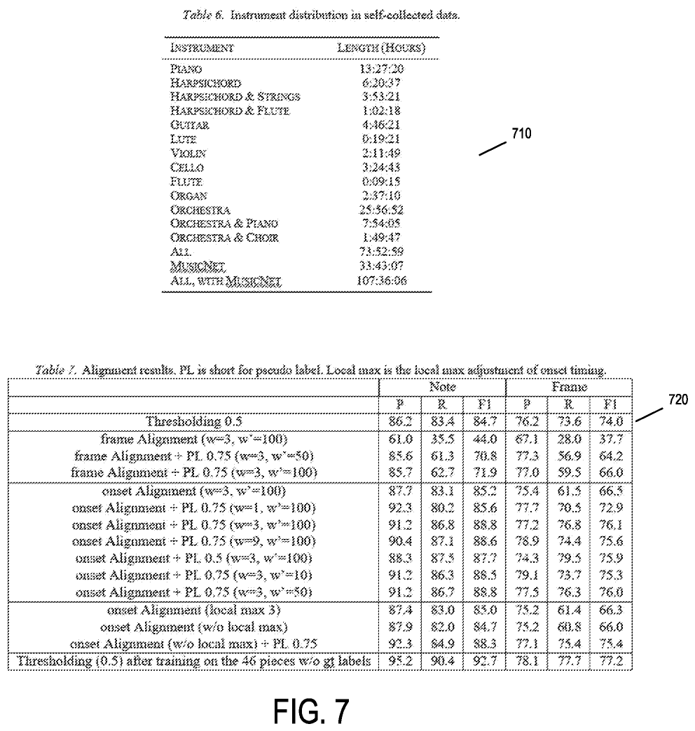

FIG. 7 shows Table Six 710 with instrument distribution in self-collected data and Table Seven 720 with alignment results according to an example of the instant disclosure.

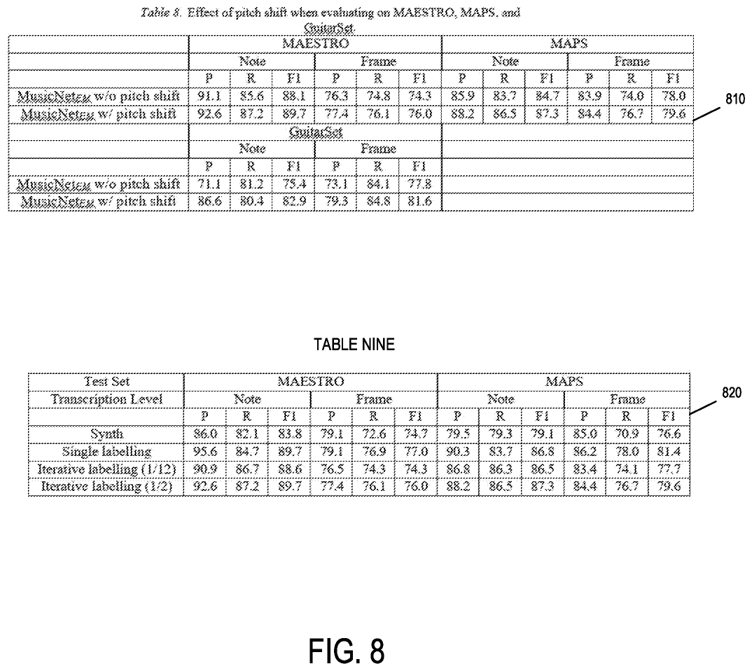

FIG. 8 shows Table Eight 810 with effect of pitch shift when evaluating on data and Table Nine 820 that shows the effect of repeated labeling according to an example of the instant disclosure.

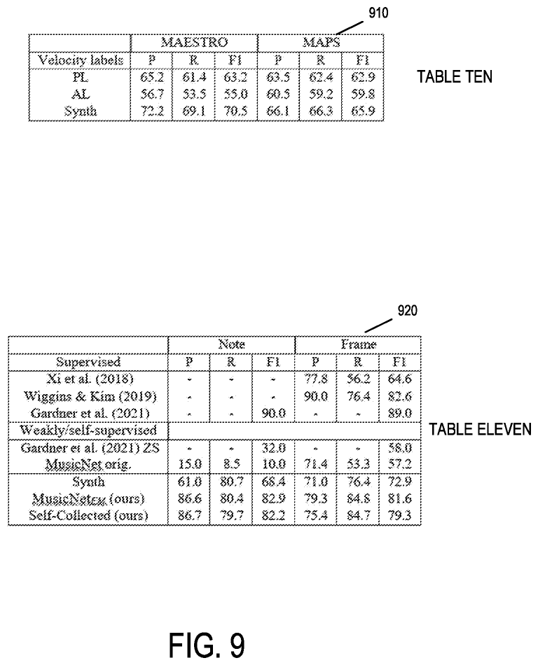

FIG. 9 shows Table Ten 910 with velocity results and Table Eleven 920 with transcription results according to an example of the instant disclosure.

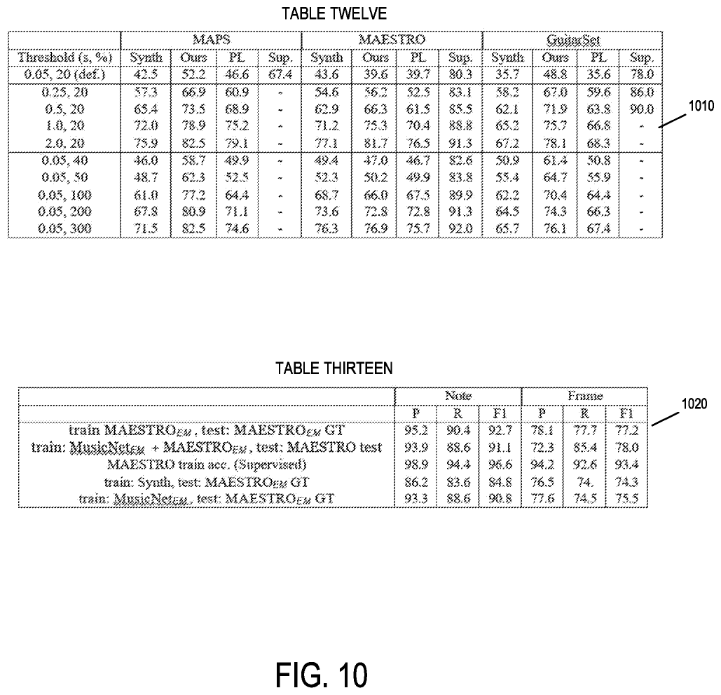

FIG. 10 shows Table Twelve 1010 with note-with-offset scores for different tolerance thresholds and Table Thirteen 1020 associated with training with unaligned supervision according to an example of the instant disclosure.

As another example, the system 100 may be used to align real data with a MIDI from a different source. This may be done by avoiding singular points.

When aligning real recordings with external MIDI (i.e., from a different performer), alignment can fail at points with a contradiction in content between the two performances. This can happen when (i) one sequence has a repeated cadenza while the other does not, or (ii) because of subtle nuances, and differences in precise timing of adjacent notes (e.g., in trills, or timing of individual notes within a chord). In such cases, the alignment will collapse a long segment of one sequence into a single frame in the other sequence. The long segment can be, e.g., one minute in case (i), or e.g., one second in case (ii). Such frames that are mapped to long segments of the other sequence are called singular points. Another solution is to verify alignment by experts, and to exclude recordings where this occurs. However, this prevents the process from being fully automatic, and is less desired. The system 100 solves the problem by only assigning labels to non-singular points, and masking the loss from singular points. Optionally, it is possible to assign pseudo-labels to singular points. This can avoid failed alignment and also leverage all data, in a fully-automated process.

In more detail, given an audio performance with frames 1, . . . , T, and an unaligned MIDI performance of the same piece with frames 1, . . . T_{target}, the initial network predicts for each frame 1≤t≤T and pitch 1≤f≤88 probabilities for onset, frame, and offset. They may be denoted these predictions: Pₒₙ, P_{fr}, P_{off}∈[0, 1]^{T×88}. Similarly, it is possible to denote by Qₒₙ, Q_{fr}, Q_{off}∈{0, 1}^{T×88} the onset, frame, and offset activations in the corresponding target midi. As local descriptors X, Y for frames of the audio recording and the midi performance respectively, it is possible to use a weighted sum:

$$X = A * {P}_{on} + B * {P}_{fr} + C * {P}_{off}$$

$$Y = A * {Q}_{on} + B * {Q}_{fr} + C * {Q}_{off}$$

$$X ∈ {R}^{T \times 88} , Y ∈ {R}^{{T}_{target} \times 88}$$

where A>>B>>C, i.e., the alignment is based mainly on the onset information. In our experiments we used values A=100, B=0.01, C=0.001. Table Seven 720 shows the significant difference in accuracy, in both note- and frame-level, when aligning according to onset information, compared to aligning according to frame information.

Given a pair of sequences X, Y the DTW algorithm returns an optimal alignment in the form of monotone multi-valued mappings (an index in the source can be mapped to multiple indices in the target):

$$M : X \to Y , {M}^{- 1} : Y \to X$$

where monotonicity implies

$$i \leq j = ⇒ k \leq {k}^{′} ∀ k ∈ M ( i ) , {k}^{′} ∈ M ( j ) .$$

and similarly for M⁻¹. We define the set of singular points S=S₁∪S₂ where

$${S}_{1} = \{ i : \vert M ( i ) \vert > w \} \qquad {S}_{2} = {U}_{j : \vert {M}^{′}} ( j ) \text{\textbar >} {w}^{′} {M}^{′} ( j )$$

S₁ is the set of indices mapped to more than w indices in the target domain (interval of length>w in the target collapses into a single frame in the source), and S₂ is the set of indices mapped to indices in the target domain that cover more than w′ indices in the source domain (interval of length>w′ in the source collapses into a single frame in the target). These window sizes control a tradeoff between precision and recall. As an example, values 3≤w≤9, w′=100. Results in Tables One 410, Two 420, and Three 510 were obtained using w=3, and results in Table Four 520 were obtained using w=7. Larger values of w cause noise as they allow imprecise onset timing, and small values of w′ (e.g., w′=3) result in transcriptions that are entirely staccato.

It is possible to then assign labels to non-singular points in the following manner: Each non-singular frame t in the source sequence is mapped to a set of frames M(t) in the target sequence, where |M(t)|≤w. It is possible to define the label \hat{X} (t, p) of frame t at pitch p to be the maximum activation of the pitch p across all frames in M(t). Since there are multiple kinds of activations—onset, frame, offset, and none—it is possible to use the hierarchy: onset>frame>offset>none.

It is possible to then assign labels only to non-singular points, in the following manner: The possible labels are: Three—onset, Two—frame, One—offset, and Zero—none. Labels can be assigned as follows \hat{X}:

$${\hat{X}}_{t} = elem wise {max}_{s ∈ M ( t )} {Z}_{s} i ∈ [ T ] \backslash S$$

Where Z is the target label, and is defined as follows:

$$Z = max \{ 3 * {Q}_{on} , 2 * {Q}_{fr} , 1 * {Q}_{off} \} ∈ {[ 3 ]}^{{T}_{target \times 88}}$$

where Qₒₙ, Q_{fr}, Q_{off} are defined as in line four in the equation in the previous section.

Note that

$${Z}_{s} ∈ {[ 3 ]}^{88} \qquad 1 \leq s \leq {T}_{target}$$

and the maximum over s in six is performed entry-wise.

It is possible to back-propagate loss only from non-singular points (unless they were marked positive/negative by the pseudo-labeling which can be performed afterwards). This enables the system 100 to leverage all data, and prevents the need to discard whole pieces because they contain singular points.

### Local-Max Adjustment

Because of the aforementioned slight differences in precise onset timing between the real recording and its corresponding MIDI, the alignment can produce small errors in onset timing. It is possible to further refine the labels for each note independently by adjusting each note onset to be a local maximum across time (according to the predicted probabilities), which allows labeling with accurate onset timing. It is possible to do the same for note offsets. Still, offsets require further investigation because they are harder to detect. This adjustment of onset timing is not possible when aligning spectral features of polyphonic music. A similar local-max adjustment can be used for annotation of guitar performances, according to flux novelty (similar to spectral features) rather than a network's predicted probabilities. This however is only possible because the different guitar strings are separated, therefore the annotation is in fact of monophonic music.

### Data & Instrument Distribution

As noted herein, the MusicNet dataset provides recordings of multiple instruments, however, the dataset is imbalanced. Most recordings are of solo piano (˜fifteen out of ˜thirty-four hours are piano solo, and ˜seven other hours include piano). It is possible demonstrate the simplicity of collecting data for our method, by gathering seventy-four additional hours of recordings. The full distribution of instruments can be seen in Table Six 710. Transcriptions in the video are by a model trained on all data, both MusicNet and the self-collected.

Table Seven 720 shows alignment results. PL is short for pseudo label. Local max is the local max adjustment of onset timing.

### Further Experiments & Ablation Studies

### Alignment Evaluation

It is possible to measure the accuracy of our labeling process on the Maestro validation dataset, for which precise annotation exists. Forty-six out of the one hundred and five pieces in the validation dataset, of total time 6:57:22, it is possible to find an additional unaligned MIDI (to be used instead of those offered with the dataset). It is possible to report the note and frame metrics of the alignment with respect to the ground truth annotation, when alignment is done over predictions of the model trained on synthetic data. Results can be compared to simple thresholding. It is possible to show the higher accuracy of aligning according to onset information rather than frame information, even for the frame-level accuracy. Results for other parameters can be shown as well. Unless otherwise stated, local-max adjustment of onset timing with a window size of seven frames can be used. It can be accomplished in an inclusive manner: after the initial alignment, if a neighbor of an onset has a higher onset prediction, it is possible to mark it as an onset instead, and repeat this three times. This can be done for both left and right neighbors, hence the small decrease in precision. All results can be seen in Table Seven 720. Accuracy can be measured on these forty-six pieces, after training on them with the labels computed by the alignment (not the ground truth labels), and the accuracy of the network can be evaluated on them using the ground truth labels (last row in Table Seven 720). Main points to note in the table are: (i) Alignment according to onset information yields much more accurate annotations than aligning according to frame information, even in the frame-level metric. (ii) While annotation according to alignment alone yields slightly better annotation than thresholding with threshold 0.5, the combination of alignment, with thresholding with a higher threshold of 0.75, performs significantly better, with improvement of 4%. (iii) The window size parameters w, w′ control a tradeoff between precision and recall. (iv) Local max adjustment significantly increases note-level recall, also increases frame-level recall, and gives a slight improvement in note- and frame-level F1 score. (v) The actual performance of the network on the forty-six pieces after training on them with the computed annotation, is higher than the annotation's accuracy.

### Pitch Shift

An ablation study measuring the effect of pitch shift augmentation can be seen in Table Eight 810 that shows that it is possible to train an additional model without pitch shift augmentation. Both models can be trained for the same time to compensate for the smaller amount of data when training without pitch shift. For piano transcription, this augmentation gives ˜2% of improvement in both note- and frame-level F1 score, increasing both precision and recall. For guitar, the improvement is 7.5% note-level and almost 4% frame-level.

### Label Update Rate

To evaluate the effect of repeated updates of annotation (repeating the E-step), three models can be trained with different policies: (i) Compute the labels once only, and train on this annotation. (ii) Update the labels twelve times during training in equal intervals. (iii) Update the labels once, in the middle of training. Single labelling had the highest precision, but lower recall. Results can be seen in Table Nine 820. Policy (iii) produced the best note-level results, while policy (i) gave the best frame-level results.

Table Eight 810 shows the effect of pitch shift when evaluating on MAESTRO, MAPS, and GuitarSet.

Table Nine 820 shows the effect of repeated labelling. It is possible to compare labeling once at the beginning of training, to labelling twice, to labelling twelve times at equal intervals. Best tradeoff between note-level precision and recall is two labeling iterations. Best frame-level performance is achieved with a single labeling iteration.

### Velocity

Dynamics and velocity are key components of any musical performance, and are a central part of the expressivity. Other previous examples incorporate velocity into their model, i.e., the model predicts the intensity in which each note was played. The designated equipment they use for data annotation (Disklavier) also provides velocity information. However, in a weakly supervised setting associated with the system 100, velocity becomes a challenge, since there is no direct way to recover the original note velocities from the training data, since the audio recording and the midi performance are from different sources, moreover, velocity is not necessarily well-defined. There might be some correlation between the real performances and the corresponding midi performances, but this is not guaranteed. Note that velocity annotation only exists for piano datasets (MAESTRO and MAPS) but neither for GuitarSet nor MusicNet.

When evaluating on the MAESTRO and MAPS test sets, the best velocity predictions were made by the initial model trained on synthetic data, as it was trained with full supervision over the velocity. i.e., the real data did not improve velocity prediction—see Table Ten 910. It is possible to use velocities from the MIDI (Table Ten AL), and using velocities predicted by the initial model as labels (Table Ten PL), but this does not improve velocity prediction. Since accurate velocity information cannot be derived from separate-source MIDI, self-supervision can be used for training velocity detection.

Table Ten 910 shows note with velocity results according to an example of the instant disclosure. In this metric, a note is considered correct only if its predicted velocity is within a threshold. In this metric the initial model trained on synthetic data performs best, as velocity information does not exist for in-the-wild recordings.

Table Eleven 920 shows full transcription results on GuitarSet. MusicNet_{EM} is the MusicNet recordings with annotation. Note-level metrics are unavailable. It is important to note that the results demonstrate generalization to a new instrument since the MusicNet recordings contain no guitar performances. Previous approaches reach high accuracy on GuitarSet when training on GuitarSet, but perform poorly in the zero-shot task (ZS), where GuitarSet data is excluded from the train set.

Table Twelve 1010 shows Note-with-offset F1 scores for different tolerance thresholds. The standard tolerance for note-with-offset is the maximum between 50 ms and 20% of the reference note length. Results are shown also for higher tolerance as follows: increase the tolerance to 250, 500, 1000, and 2000 rms, keeping the 20% threshold fixed (rows 4-7), and increase the tolerance to 40, 50, 100, 200, 300%, keeping the 50 ms threshold fixed (rows 8-12). For low tolerance, results are inconclusive between the model trained on synthetic data, the methods discussed herein, and pseudo-labels. As can be expected, as the tolerance increases, the note-with-offset F1 score becomes closer to the note-level F1 score, and when reaching a 0.25 s tolerance (rows 4-7), the methods discussed herein achieve highest note-with-offset F1 score on all three test sets.

### Guitarset Full Metrics

Results can be seen in Table Eleven 920.

### Frame & Offset Detection

Onsets by definition are the initial appearance, or beginning of notes, and their lengths do not vary between notes—long notes and short notes have an onset with the same length, which is typically defined to be a single frame. Thus, there is a strict correspondence between onsets in a real performance and its corresponding midi, up to a warping function. However, frame activation determines the duration of a note, which lasts several frames and can significantly vary between different notes. The musical score of a piece has instructions for note duration, which provides approximate information that enables learning frame-level transcription in the weakly supervised setting. However, small discrepancies can exist between the real and the midi performances, even after warping, as the exact time of offset can slightly vary between performances.

Therefore, although there is improvement in frame-level accuracy gained through weak supervision, it is moderate. These small discrepancies in performance explain the gap between supervised and weakly supervised learning in the frame-level accuracy in Table One (79.6-81.4% vs. 84.9%) and between note-level accuracy and frame-level accuracy in the weakly supervised setting (79.6-81.4% vs. 87.3%). However, as noted herein, the human ear is sensitive mainly to the onset time, and less to the notes' precise duration and offset time, assuming note duration is approximately correct.

To measure the accuracy of our trained model in detecting note offsets, it is possible compute the note-with-offset level metrics for different thresholds. The standard tolerance for offset detection is 50 milliseconds, or 20% of the note length, whichever is greater. Results can be seen in Table Twelve 1020. It can be seen that the contribution of unaligned supervision to offset detection is small, and increases as the offset tolerance thresholds are increased.

Frame-level detection, together with offset detection, can be further improved through self-supervision.

Table Thirteen 1020 shows training on MAESTRO with unaligned supervision. For ˜seven hours of the MAESTRO validation set, it is possible find unaligned MIDI of the same pieces from unrelated performers, and denote this data MAESTRO_{EM}. First row shows accuracy when training on MAESTRO_{EM} and evaluating on MAESTRO_{EM}, but with respect to the GT labels. Second row shows training on both MAESTRO_{EM} and MusicNet_{EM}, and evaluating on the MAESTRO test set. Metrics in row 3 are from a previous approach. There is a small gap in note-level metrics between rows 1 (unaligned supervision) and 3 (full supervision).

MAESTRO with Unaligned Supervision

Some important questions arise: What is the accuracy on the test set, when some samples from the test domain, or samples similar to the test domain, are seen during training, but without labels, only unaligned supervision? To evaluate this, it is possible to search for midi performances of pieces in the MAESTRO dataset, unaligned, and by other performers. Such performances can be found for forty-six pieces from the MAESTRO validation set, of total time 6:57:22. They are denoted by MAESTRO_{EM}. Two experiments can be conducted: (i)train on MAESTRO_{EM} alone using the methods discussed herein, without the ground truth labels, and then measure accuracy on MAESTRO_{EM} with respect to the ground truth labels. (ii) In another experiment, add MAESTRO_{EM} to MusicNet_{EM} to measure the effect on the MAESTRO test set. Results can be seen in Table Thirteen 1020, rows 1-2.

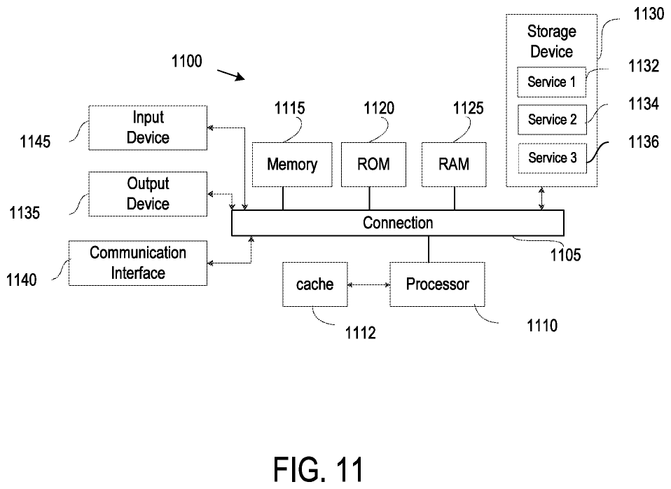

FIG. 11 shows an example of computing system 1100, which can be for example any computing device making up the computing device such as the computing device, or any component thereof in which the components of the system are in communication with each other using connection 1105. Connection 1105 can be a physical connection via a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache of high-speed memory 1112 connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms known to those of skill in the art. In some instances, multimodal systems can enable a user to provide multiple types of input/output to communicate with computing system 1100. Computing system 1100 can include communications interface 1140, which can generally govern and manage the user input and system output. There is no restriction on operating on any particular hardware arrangement, and therefore the basic features here may easily be substituted for improved hardware or firmware arrangements as they are developed.

Storage device 1130 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A system comprising: a memory storing computer-readable instructions; and at least one processor to execute the instructions to perform pre-training of a machine learning model using synthetic data comprising random music instrument digital interface (MIDI) files; receive a first library of audio files, receive a second library of MIDI files, each MIDI file having a corresponding audio file in the first library, align each midi file in the second library with the corresponding audio file in the first library, feed the first library and the second library into the machine learning model to train the machine learning model to perform musical transcribing of at least one musical instrument in an audio file, and receive an audio file and perform automatic transcription of at least one musical instrument in an audio file using the machine learning model based on expectation maximization.

Aspect 2: The system of Aspect 1, the at least one processor further to execute the instructions to train the machine learning model using a transcriber trained for instrument insensitive transcription using the synthetic data.

Aspect 3: The system of Aspects 1 and 2, the at least one processor further to execute the instructions to perform the automatic transcription at a note-level accuracy.

Aspect 4: The system of Aspects 1 to 3, the at least one processor further to execute the instructions to perform the automatic transcription to predict an instrument for each note in the audio file having multiple simultaneous musical instruments.

Aspect 5: The system of Aspects 1 to 4, the at least one processor further to execute the instructions to generate annotation for each audio file in the first library using the corresponding MIDI file.

Aspect 6: The system of Aspects 1 to 5, the at least one processor further to execute the instructions to align each audio file in the first library with the corresponding MIDI file in the second library using onset information.

Aspect 7: The system of Aspects 1 to 6, the at least one processor further to execute the instructions to align each audio file in the first library with the corresponding MIDI file in the second library using dynamic time warping.

Aspect 8: The system of Aspects 1 to 7, the at least one processor further to execute the instructions to train the machine learning model using one of unsupervised learning or weakly supervised learning.

Aspect 9: The system of Aspects 1 to 8, wherein the first library comprises the MusicNet database.

Aspect 10: The system of Aspects 1 to 9, wherein the expectation maximization (EM) comprises an E-Step having an equation comprising:

$${y}_{1} , … , {y}_{n} = {arg max}_{{y}_{1} , … , {y}_{n}} {P}_{Θ} ( {a}_{1} , … , {a}_{n} , {y}_{1} , … , {y}_{n} ) ,$$

each a being a data sample and each y being an unknown per-frame label.

Aspect 11: The system of Aspects 1 to 10, wherein the expectation maximization (EM) comprises an M-Step having an equation comprising:

$$Θ = {arg max}_{Θ} {P}_{Θ} ( {a}_{1} , … , {a}_{n} , {y}_{1} , … , {y}_{n} ) ,$$

each a being a data sample and each y being an unknown per-frame label.

Aspect 12: The system of Aspects 1 to 11, wherein the expectation maximization (EM) comprises an equation comprising:

$${Θ}^{*} = {arg max}_{Θ} {max}_{{y}_{1} , … , {y}_{n}} {P}_{Θ} ( {a}_{1} , … , {a}_{n} , {y}_{1} , … , {y}_{n} ) .$$

Aspect 13: The system of Aspects 1 to 12, wherein the at least one musical instrument comprise a piano, a guitar, a string instrument, and a wind instrument.

Aspect 14: The system of Aspects 1 to 13, the at least one processor further to execute the instructions to perform instrument-sensitive training by detecting a note active on all instruments and label each note using the expectation maximization (EM).

Aspect 15: The system of Aspects 1 to 14, the at least one processor further to execute the instructions to perform labeling by assigning labels to non-singular points and masking a loss to singular points.

Aspect 16: The system of Aspects 1 to 15, wherein the labeling comprises labeling when a predicted confidence is above a particular threshold.

Aspect 17: The system of Aspects 1 to 16, wherein each audio file in the first library comprises one of a Free Lossless Audio Codec (flac) file and a MPEG-1 Audio Layer 3 (mp3) file.

Aspect 18: The system of Aspects 1 to 17, wherein the machine learning model is generated using a machine learning architecture comprising long short-term memory (LSTM) layers having a size 384, convolutional filters having a size 64/64/128, and linear layers having a size 1024.

Aspect 19: The system of Aspects 1 to 18, the at least one processor further to execute the instructions to use transfer learning to generate the machine learning model.

Aspect 20: The system of Aspects 1 to 19, the at least one processor further to execute the instructions to perform instrument sensitive training by detecting a note active on all instruments.

Aspect 21: A method comprising performing, by at least one processor, pre-training of a machine learning model using synthetic data comprising random music instrument digital interface (MIDI) files, receiving, by the at least one processor, a first library of audio files, receiving, by the at least one processor, a second library of MIDI files, each MIDI file having a corresponding audio file in the first library, aligning, by the at least one processor, each midi file in the second library with the corresponding audio file in the first library, feeding, by the at least one processor, the first library and the second library into the machine learning model to train the machine learning model to perform musical transcribing of at least one musical instrument in an audio file, and receiving, by the at least one processor, an audio file and performing automatic transcription of at least one musical instrument in an audio file using the machine learning model based on expectation maximization.

Aspect 22: A non-transitory computer-readable storage medium, having instructions stored thereon that, when executed by a computing device cause the computing device to perform operations, the operations comprising performing pre-training of a machine learning model using synthetic data comprising random music instrument digital interface (MIDI) files, receiving a first library of audio files, receiving a second library of MIDI files, each MIDI file having a corresponding audio file in the first library, aligning each midi file in the second library with the corresponding audio file in the first library, feeding the first library and the second library into the machine learning model to train the machine learning model to perform musical transcribing of at least one musical instrument in an audio file, and receiving an audio file and performing automatic transcription of at least one musical instrument in an audio file using the machine learning model based on expectation maximization.

1. A system comprising:
a memory storing computer-readable instructions; and
at least one processor to execute the instructions to:
perform pre-training of a machine learning model using synthetic data comprising random music instrument digital interface (MIDI) files;
receive a first library of audio files;
receive a second library of MIDI files, each MIDI file in the second library of MIDI files having a corresponding audio file in the first library;
align each midi file in the second library of MIDI files with the corresponding audio file in the first library;
feed the first library and the second library into the machine learning model to train the machine learning model to perform musical transcribing of at least one musical instrument; and
receive an audio file and, using the machine learning model based on expectation maximization, perform automatic transcription of the at least one musical instrument in the audio file.

2. The system of claim 1, wherein the at least one processor further executes the instructions to train the machine learning model using a transcriber, wherein the transcriber is trained for instrument insensitive transcription using the synthetic data.

3. The system of claim 1, wherein the at least one processor further executes the instructions to perform the automatic transcription at a note-level accuracy.

4. The system of claim 1, wherein the at least one processor further executes the instructions to perform the automatic transcription to predict an instrument for each note in the audio file having multiple simultaneous musical instruments.

5. The system of claim 1, wherein the at least one processor further executes the instructions to generate annotation for each audio file in the first library using the corresponding MIDI file in the second library.

6. The system of claim 1, wherein the at least one processor further executes the instructions to align each audio file in the first library with the corresponding MIDI file in the second library using either onset information or dynamic time warping.

7. (canceled)

8. The system of claim 1, wherein the at least one processor further executes the instructions to train the machine learning model using one of: unsupervised learning or weakly supervised learning.

9. The system of claim 1, wherein the first library comprises the MusicNet database.

10. The system of claim 1, wherein the expectation maximization (EM) comprises an E-Step having an equation comprising:
$${y}_{1} , … , {y}_{n} = {arg max}_{{y}_{1} , … , {y}_{n}} {P}_{Θ} ( {a}_{1} , … , {a}_{n} , {y}_{1} , … , {y}_{n} ) ,$$
each a being a data sample and each y being an unknown per-frame label.

11. The system of claim 1, wherein the expectation maximization (EM) comprises an M-Step having an equation comprising:
$$Θ = {arg max}_{Θ} {P}_{Θ} ( {a}_{1} , … , {a}_{n} , {y}_{1} , … , {y}_{n} ) ,$$
each a being a data sample and each y being an unknown per-frame label.

12. The system of claim 1, wherein the expectation maximization (EM) comprises an equation comprising:
$${Θ}^{*} = {arg max}_{Θ} {max}_{{y}_{1} , … , {y}_{n}} {P}_{Θ} ( {a}_{1} , … , {a}_{n} , {y}_{1} , … , {y}_{n} ) .$$

13. The system of claim 1, wherein the at least one musical instrument comprises a piano, a guitar, a string instrument, and a wind instrument.

14. The system of claim 1, wherein the at least one processor further executes the instructions to perform instrument-sensitive training by detecting at least one note active on all instruments and labeling the at least one note using the expectation maximization (EM).

15. The system of claim 14, wherein the at least one processor further executes the instructions to perform labeling by assigning labels to non-singular points and masking a loss to singular points, wherein the labeling occurs when a predicted confidence is above a particular threshold.

16. (canceled)

17. The system of claim 1, wherein each audio file in the first library is selected from the group consisting of: a Free Lossless Audio Codec (flac) file, and a MPEG-1 Audio Layer 3 (mp3) file.

18. The system of claim 1, wherein the machine learning model is generated using a machine learning architecture comprising long short-term memory (LSTM) layers having a size 384, convolutional filters having a size 64/64/128, and linear layers having a size 1024.

19. The system of claim 1, wherein the at least one processor further executes the instructions to use transfer learning to generate the machine learning model.

20. The system of claim 1, wherein the at least one processor further executes the instructions to perform instrument sensitive training by detecting at least one note active on all instruments.

21. A method, comprising:
performing, by at least one processor, pre-training of a machine learning model using synthetic data comprising random music instrument digital interface (MIDI) files;
receiving, by the at least one processor, a first library of audio files;
receiving, by the at least one processor, a second library of MIDI files, each MIDI file in the second library of MIDI files having a corresponding audio file in the first library;
aligning, by the at least one processor, each midi file in the second library of MIDI files with the corresponding audio file in the first library;
feeding, by the at least one processor, the first library and the second library into the machine learning model to train the machine learning model to perform musical transcribing of at least one musical instrument; and
receiving, by the at least one processor, an audio file and, using the machine learning model based on expectation maximization, performing automatic transcription of the at least one musical instrument in the audio file.

22. A non-transitory computer-readable storage medium, having instructions stored thereon that, when executed by a computing device, cause the computing device to perform operations, the operations comprising:
performing pre-training of a machine learning model using synthetic data comprising random music instrument digital interface (MIDI) files;
receiving a first library of audio files;
receiving a second library of MIDI files, each MIDI file in the second library of MIDI files having a corresponding audio file in the first library;
aligning each midi file in the second library of MIDI files with the corresponding audio file in the first library;
feeding the first library and the second library into the machine learning model to train the machine learning model to perform musical transcribing of at least one musical instrument; and
receiving an audio file and, using the machine learning model based on expectation maximization, performing automatic transcription of the at least one musical instrument in the audio file.
